(19) United States
(12) Patent Application Publication
(10) Pub. No.: US 2008/0053965 A1
(43) Pub. Date: Mar. 6, 2008

(54) METHOD OF MIXING SHIELDING GASES FOR WELDING

(76) Inventors: Scott Laymon, Kingston, GA (US); Frederic Schweighardt, Cypress, TX (US)

Correspondence Address: AIR LIQUIDE INTELLECTUAL PROPERTY DEPT., 2700 POST OAK BLVD., SUITE 1800, HOUSTON, TX, 77056, US

(21) Appl. No.: 11/613,163

(22) Filed: Dec. 19, 2006

Related U.S. Application Data
(60) Provisional application No. 60/776,719, filed on Feb. 24, 2006.

(51) Int. Cl. B23K 9/16; B23K 35/38

(52) U.S. Cl. 219/74

(57) ABSTRACT

A method and apparatus of forming a shielding gas mixture at a worksite includes providing a first gas in a liquefied state; providing a second gas in a gaseous state; vaporizing the first gas to a gaseous state; and blending the first gas with the second gas to form the shielding gas mixture.

### CROSS-REFERENCE TO RELATED APPLICATIONS

This application claims the benefit under 35 U.S.C. §119(e) to provisional application No. 60/776,719, filed Feb. 24, 2006, the entire contents of which are incorporated herein by reference.

### BACKGROUND

Arc welding is a welding process commonly used to join two metal workpieces. Arc welding involves generating an intensely hot electric arc between an electrode and a metal workpiece. The heat generated by this arc melts the filler metal material used to make the weld as well as the base material. In the GMAW (Gas Metal Arc Welding) process, the filler metal is the electrode itself, which is consumed and becomes part of the weld. This consumable electrode may be a long wire, typically wound on a spool that is continuously fed to the weld through a current-carrying welding gun. In contrast, the electrode in gas tungsten arc welding (“GTAW”) is not consumed and the filler material is separately provided.

During arc welding processes, it is preferable to protect the molten weld metal (also known as “weld pool”) under the arc from certain elements in the atmosphere, such as oxygen, nitrogen, and hydrogen. These elements may react with the molten metal and cause problems, such as sputtering or the forming of oxides, nitrides, or hydrides, which can adversely affect the integrity of the weld. A common method of protecting the hot and reactive weld metal is to surround the weld metal with inert shielding gases until the weld metal cools. The shielding gas may be delivered to the arc using the welding gun. The shielding gas shrouds the weld pool and is effective in preventing the weld pool and the subsequent weld from being oxidized or corroded by air or other contaminants.

Depending on the weld process, the shielding gas may be a mixture of two or more gases. Inert gases such as argon and helium are typically employed as the primary shielding gas. Small amounts of active gases such as oxygen and carbon dioxide have been mixed with the selected inert gas or gases. Each of the gases, and the relative ratio, in a shielding gas mixture may have a substantial effect on the welding operation. For example, argon may affect the arc transfer, ionization potential, and arc plasma. Helium, carbon dioxide, or oxygen may affect heat input, penetration, and, depending on concentration, will determine the type of material on which the gas may be used. As such, the composition of the shielding gas may contain a mixture of gases tailored specifically for a particular job.

Prior to welding, the welder must determine the proper shielding gas mixture for the particular project. Premixed gas mixtures in the proper proportions may be requested and obtained from gas suppliers. The premixed gas mixtures may be used at the worksite “as is.” Alternatively, each gas may be obtained in separate gas tanks and mixed at the worksite.

For projects that require a large quantity of shielding gas, the transport of premixed shielding gas to the worksite may substantially increase the costs of the project. This is partly due to the gas phase taking up more volume than the liquid phase, therefore, more gas tanks or containers must be transported if a premixed shielding gas in a gaseous state is used. Additionally, measures required to maintain the premixed gas in gaseous state during transport also increase the costs. The option of mixing the separate gas components at the worksite to form the shielding gas mixture also has drawbacks. For example, some shielding gas mixtures require one of the gases to be present in small concentrations. However, many commercially available gas mixers are inadequate to mix the needed gas to the required small concentration.

There is a need, therefore, for a method to produce a shielding gas mixture for welding. There is a further need for a method to more effectively mix a shielding gas mixture at the worksite.

### SUMMARY

Embodiments of the present invention provide methods and apparatus to mix a plurality of gases to form a shielding gas mixture. In one embodiment, the method includes providing a first gas in a liquefied state; providing a second gas in a gaseous state; vaporizing the first gas to a gaseous state at the worksite; and blending the first gas with the second gas to form the shielding gas mixture suitable for a welding application at the worksite. In another embodiment, at least one of the first gas and the second gas includes at least two different gases. In yet another embodiment, a mechanical mixer is used to blend the first gas with the second gas.

In another embodiment, a method of forming a shielding gas mixture at a worksite at which the shielding gas mixture is used in a welding application includes providing a first gas in a liquefied state; vaporizing the first gas to a gaseous state at the worksite; blending the first gas with a second gas to form the shielding gas mixture suitable for the welding application; and flowing the shielding gas mixture proximate a weld pool formed on a workpiece located at the worksite.

In yet another embodiment, an apparatus for supplying a shield gas mixture at a worksite at which the shielding as mixture is used includes a liquid gas storage vessel for storing a first gas in liquefied state; a vaporizer for vaporizering the first gas; a gas storage vessel for storing a second gas; and a gas mixer for mixing the first gas and the second gas.

In yet another embodiment, an apparatus for supplying a tri-mix shielding gas at a worksite at which the tri-mix shielding gas is used includes a liquid gas storage vessel for storing a gas blend containing a first gas and a second gas pre-blended in an homogenized liquid state; a vaporizer for vaporizering the gas blend; a gas storage vessel for storing a third gas; and a gas mixer for mixing the gas blend and the third gas to produce the tri-mix shielding gas.

In yet another embodiment, a method of forming a tri-mix shielding gas at a worksite at which the tri-mix shielding gas is used in a welding application includes providing a gas blend containing a first gas and a second gas in an homogenized liquid state; vaporizing the gas blend; providing a third gas; and mixing the vaporized gas blend and the third gas, there by producing the tri-mix shielding gas.

### BRIEF DESCRIPTION OF THE DRAWINGS

For a further understanding of the nature and objects of the present invention, reference should be made to the following detailed description, taken in conjunction with the accompanying drawings, in which like elements are given the same or analogous reference numbers and wherein:

FIG. 1 illustrates gas mixing assembly according to one embodiment of the present invention; and

FIG. 2 illustrates an exemplary flow diagram of a gas mixer.

### DESCRIPTION OF PREFERRED EMBODIMENTS

Embodiments of the present invention provide methods and apparatus to mix a plurality of gases to form a shielding gas mixture. In one embodiment, the method includes providing a first gas in a liquefied state, vaporizing the first gas to a gaseous state, and blending the first gas with a second gas in a gaseous state to form the shielding gas mixture. In another embodiment, at least one of the first gas and the second gas includes at least two different gases. In yet another embodiment, a mechanical mixer is used to blend the first gas with the second gas.

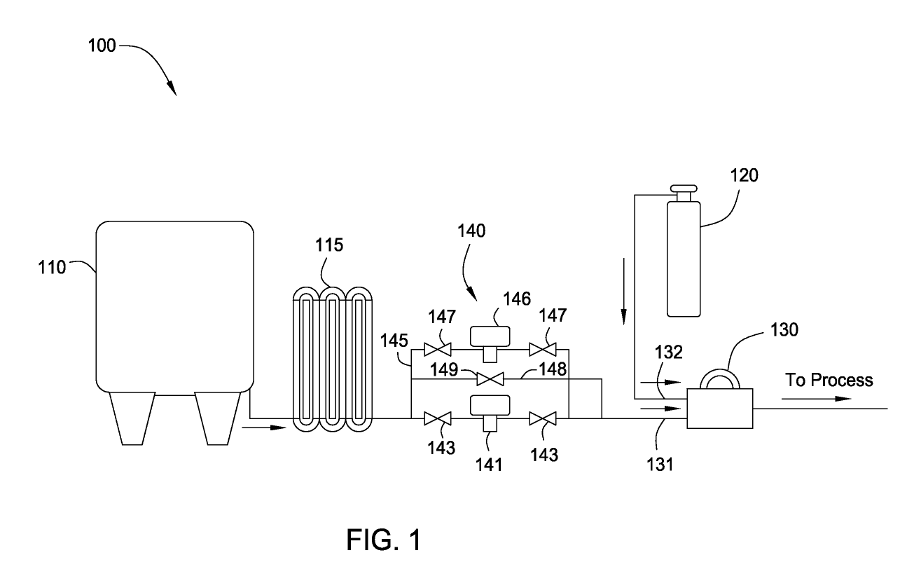

FIG. 1 shows a gas mixing assembly 100 suitable for forming a shielding gas mixture. The mixing assembly includes a first storage vessel 110 for storing a first gas in a liquefied state. The first storage vessel 110 may be a tank, a cylinder, or any suitable gas storage vessel for storing a gas in liquefied state. In one embodiment, the first storage vessel 110 is an insulated, vacuum-jacketed pressure vessel such as a cryogenic liquid cylinder. The first storage vessel 110 may be equipped with safety relief valves and/or rupture disks to control the internal pressure and vent valves to provide ventilation. The storage vessel 110 may be a transportable vessel delivered to the worksite or a non-portable vessel located at the worksite. Suitable storage vessels are commercially available from suppliers such as Chart Industries, Inc. The first gas stored in the first storage vessel 110 may be a single gas or a mixture of two or more gases in liquefied state. For example, the first gas stored in the first storage vessel 110 may include two gases that are pre-blended in a homogenized liquid state. In one embodiment, the first gas includes the gas that will make up the major component of the shielding gas mixture. In this respect, transport of the first gas in liquid form may decrease the costs of the welding project.

The first storage vessel 110 is connected to a gas vaporizer 115 for transforming the first gas from liquefied state to gaseous state before it is delivered to the gas mixer 130. In one embodiment, the gas vaporizer 130 is a heat exchanger designed to vaporize a liquid. The energy needed to vaporize the liquid gas may be obtained from the surroundings. An ambient vaporizer takes heat from the surrounding air and transfers it to the liquid gas flowing through its coils. The air outside the vaporizer wall is much warmer than the liquid gas, which may be about −280 to −420° F., thus making the ambient air an effective heat exchange medium. Heat is transferred or pushed across the wall or fin of the ambient vaporizer into the liquid gas. Suitable vaporizers are commercially available from suppliers such as Thermax, Inc. Other exemplary vaporizers include a cryogenic vaporizer, a convection vaporizer, and a conduction vaporizer.

After vaporization, the first gas is delivered to the gas mixer 130 for mixing with other components of the shielding gas mixture. The flow of the first gas to the gas mixer 130 may be regulated by one or more regulators 141 and valves 143. Referring to FIG. 1, a regulation station 140 is disposed between the vaporizer 115 and the gas mixer 130. In one embodiment, the regulation station 140 includes a primary regulator 141 and one or more valves 143 to control the flow of the first gas. The primary regulator 141 is designed to reduce the pressure of the first gas flowing from the first storage vessel 110 to the gas mixer 130 such that the pressure of the first gas is suitable for welding purposes. Any suitable regulator and valves known to a person of ordinary skill may be used. The regulation station 140 may further include a bypass gas line 145 having a secondary regulator 146 and valves 147 to bypass the flow of the first gas around the first regulator 141. In another embodiment, a bypass gas line 148 may simply include a valve 149. The first gas leaving the regulation station 140 is directed to the first gas input 131 of the gas mixer 130.

The gas mixing assembly 100 also includes a second gas storage vessel 120 for storing a second gas. In one embodiment, the second gas storage vessel 120 is adapted to store the second gas in a gaseous state. Exemplary second gas storage vessels include a cylinder or a tank adapted to store gas under pressure. A regulator and a valve (not shown) may be attached to the second gas storage vessel 120 to regulate the flow of the second gas to the gas mixer 130. In one embodiment, the second gas may be a single gas or a mixture of different gases. In one embodiment, the second gas makes up a smaller percentage of the shielding gas mixture relative to the first gas in order to reduce the cost associated with transporting the second gas. The second gas leaving the second gas storage vessel 120 is directed to the second gas input 132 of the gas mixer 130.

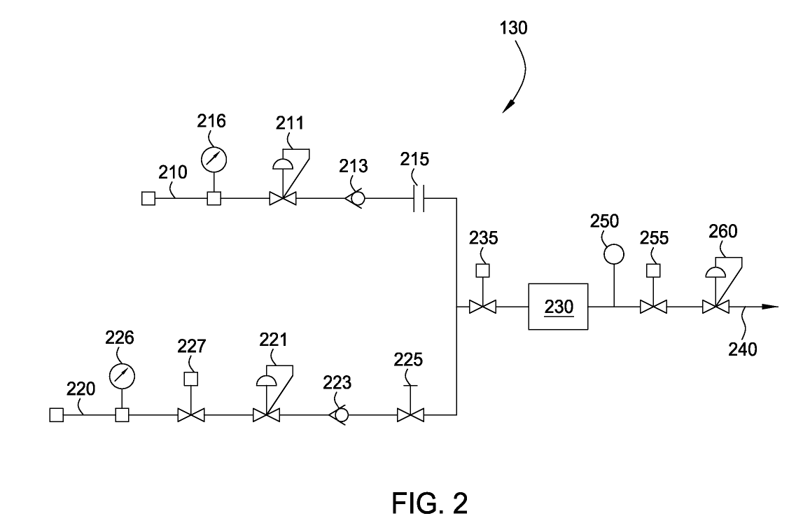

The first gas and the second gas may be combined to form the shielding gas mixture using the gas mixer 130. In one embodiment, a two component (i.e., two input) gas mixer 130 may be used to the mix the gases. However, a gas mixer having three or more input gas streams may also be used. Suitable gas mixers are commercially available from suppliers such as Thermco Instrument Corporation. FIG. 2 illustrates a process flow diagram for an exemplary gas mixer 130 suitable for use with embodiments of the present invention. As shown, the first gas (e.g., major gas) is supplied through a first gas line 210 having a regulator 211 optionally equipped with a pressure gauge. Downstream from the regulator 211 is a check valve 213 to prevent reverse flow of the major gas and an orifice 215 for gas flow. Similarly, the second gas (e.g., minor gas) is supplied through a second gas line 220 having a regulator 221 and a check valve 223 located downstream. The second gas line 220 also includes a mixture adjustment valve 225 which acts as an adjustable orifice, whereby the concentration of the minor gas may be adjusted. Each gas line 210, 220 may optionally include low gas inlet pressure switch 216, 226 and shutoff solenoid valve 227 to facilitate control of the gas flows.

Before mixing, the major gas and the minor gas are regulated to the same pressure. The two gases are mixed together under turbulent conditions and fed into a surge tank 230. A cycling valve 235 may be used to control the feed into the tank 230. The outlet line 240 includes a pressure switch 250 to monitor the pressure in the surge tank 230 and a mixture outlet regulator 260. The operation of the cycling valve 235 will initially allow the mixed gas to fill the surge tank 230 until an upper pressure limit is reached. Then, the cycling valve 235 closes and the supply of mixed gas to the surge tank 235 is stopped. Depletion of the mixed gas from use will cause a drop in the pressure of the surge tank 230. Once the pressure in the surge tank 230 reaches a lower limit, the cycling valve 235 is opened and the cycle repeats.

The gas mixer may 130 may include a gas analyzer 255 to continuously monitor the shielding gas mixture in the surge tank 230. If the ratio of the shielding gas mixture requires adjustment, the mixture adjustment valve 225 may be controlled to change the flow of the minor gas for mixing. In this respect, only the minor gas flow is changed in order to adjust the proportions of the gases in the shielding as mixture. The gas analyzer 255 can measure the new gas mixture to ensure the desired ratio is obtained. In another embodiment, the major gas stream and/or the minor gas stream may be adjusted to change the proportions of the gases in the shielding gas mixture.

In one embodiment, the shielding gas mixing process may be used to form a shielding gas mixture having a major gas and at least two minor gases. In one embodiment, the major gas may make up at least 60% by volume, more preferably, 75% by volume, of the shielding gas mixture. Exemplary major gases include argon and helium. A minor gas may make up less than 50% by volume; more preferably, 25% by volume; most preferably, less than 10% by volume, of the shielding gas mixture. In some cases, a minor gas may be as low as 2% or less of the gas mixture. Exemplary minor gases include oxygen, carbon dioxide, helium, nitrogen, and combinations thereof.

Following are examples of forming a shielding gas mixture according to embodiments of the present invention.

### EXAMPLE 1

A shielding gas mixture is prepared using a liquid argon blend mixed with carbon dioxide gas. The argon blend contains 95% argon and 5% oxygen. Initially, the argon blend is stored in liquefied state in the bulk storage tank 110 located at the worksite. The argon blend is stored at about −250° F. and about 150 psi. The carbon dioxide is stored as a gas in a cylinder 120 at ambient temperature and 875 psi. See Table 1A below. To begin mixing, the argon blend is supplied to the ambient vaporizer 115, where it is vaporized from the liquefied state to the gaseous state. The argon blend may be supplied at a flow rate between 10 to 1,000 SCFH. The argon blend is at ambient temperature when it leaves the vaporizer 115. The pressure of the argon blend is reduced to about 125 psi. as it travels through the primary regulator 141. The argon blend is directed to the major gas input 131 of the gas mixer 130. The carbon dioxide also passes through a regulator before it is supplied to the minor gas input 132 of the gas mixer 130. The carbon dioxide is supplied at the same temperature as the argon blend and at a flow rate between 10 to 1,000 SCFH. The carbon dioxide also passes through a regulator which reduces its pressure to about 125 psi.

At the gas mixer 130, both gas streams are regulated to the same pressure before mixing. The proportions in the shielding gas mixture are controlled by the mixture adjustment valve 225, which is designed to control the carbon dioxide flow rate. Thus, the proportions in the shielding gas mixture are controlled by changing the flow rate for the carbon dioxide while maintaining a constant flow rate for the argon blend. In Table 1B, the gas mixer is set to mix a shielding gas mixture having 5% carbon dioxide and 95% of the argon blend. The result of the mixing is a shielding gas mixture containing 90.3% argon, 4.8% oxygen, and 5% carbon dioxide. The shielding gas mixture leaves the gas mixer at ambient temperature about 50 psi. Based on a 2,000 SCFH gas mixer, shielding gas mixture will contain 1806 SCFH of argon, 94 SCFH of oxygen, and 100 SCFH of carbon dioxide. The resulting shielding gas mixture is suitable for welding mild steel using the GMAW process.

TABLE 1A

| | Composition | | |
|---|---|---|---|
| | | | Carbon |
| | Argon | Oxygen | Dioxide |
| Carbon | 0% | 0% | 100% |
| Dioxide | | | |
| Argon | 95% | 5% | 0% |
| Blend | | | |

TABLE 1B
Final Gas Mix

| Mixer | | | Carbon |
|---|---|---|---|
| Setting | Argon | Oxygen | Dioxide |
| 5% | 0% | 0% | 5% |
| 95% | 90.3% | 4.8% | 0% |
| Total | 90.3% | 4.8% | 5% |

### EXAMPLE 2

An argon/helium/carbon dioxide shielding gas mixture is formed by mixing liquid argon and a helium gas blend containing 5% carbon dioxide. See Table 2A. After vaporization, the argon is directed to the gas mixer for mixing with the helium blend. The mixer is set to mix a shielding gas having 80% argon and 20% helium blend. The result of the mixing is a shielding gas mixture containing 80% argon, 19% helium, and 1% carbon dioxide. See Table 2B. As shown, one advantage of this mixing process is that a low percentage gas component (e.g., 2% or less) may be accurately formed in the gas mixture using a commercially available gas mixer. The resulting shielding gas mixture is suitable for welding stainless steel using the GMAW process.

TABLE 2A

| | Composition | | |
|---|---|---|---|
| | | | Carbon |
| | Argon | Helium | Dioxide |
| Helium | 0% | 95% | 5% |
| Blend | | | |
| Argon | 100% | 0% | 0% |

TABLE 2B
Final Gas Mix

| Mixer | | | Carbon |
|---|---|---|---|
| Setting | Argon | Helium | Dioxide |
| 20% | 0% | 19% | 1% |
| 80% | 80% | 0% | 0% |
| Total | 80% | 19% | 1% |

### EXAMPLE 3

A four component shielding gas mixture is formed by mixing liquid argon blend containing 5% oxygen and a helium gas blend containing 5% carbon dioxide. See Table 3A. After vaporization, the argon blend is directed to the gas mixer for mixing with the helium blend. The mixer is set to mix a shielding gas having 80% argon blend and 20% helium blend. The result of the mixing is a shielding gas mixture containing 80.8% argon, 4.3% oxygen, 12% helium, and 3% carbon dioxide. See Table 3B. The resulting shielding gas mixture is suitable for welding carbon steel using the GMAW process.

TABLE 3A

Composition

| | Ar | O₂ | He | CO₂ |
|---|---|---|---|---|
| Helium | 0% | 0% | 80% | 20% |
| Blend | | | | |
| Argon | 95% | 5% | 0% | 0% |
| Blend | | | | |

TABLE 3B
Final Gas Mix

| Mixer | | | | |
|---|---|---|---|---|
| Setting | Ar | O₂ | He | CO₂ |
| 20% | 0% | 0% | 12% | 3% |
| 80% | 81% | 4% | 0% | 0% |
| Total | 80.8% | 4.3% | 12% | 3% |

In addition to these examples, embodiments of the present invention contemplate other suitable variations and modifications readily apparent to a person of ordinary skill in the art. For example, one or both of the gas streams (first and second) may be in liquefied state and vaporized before it is supplied to the gas mixer. Additionally, each gas stream may contain one or more gases. Embodiments of the present invention may be used to prepare a shielding gas mixture having three or more gases. In another embodiment, the gas mixer may have two or more gas stream inputs. In addition, the shielding gas mixtures may be used in a GMAW process to perform various types of welds, such as butt joint, lap joint, edge joint, T-joint, corner joint, V joints, U joints, and combinations thereof.

Preferred processes and apparatus for practicing the present invention have been described. It will be understood and readily apparent to the skilled artisan that many changes and modifications may be made to the above-described embodiments without departing from the spirit and the scope of the present invention. The foregoing is illustrative only and that other embodiments of the integrated processes and apparatus may be employed without departing from the true scope of the invention defined in the following claims.

What is claimed is:

1. A method of forming a shielding gas mixture at a worksite at which the shielding gas mixture is used, comprising:
providing a first gas in a liquefied state;
providing a second gas in a gaseous state;
vaporizing the first gas to a gaseous state at the worksite; and
blending the first gas with the second gas to form the shielding gas mixture suitable for a welding application at the worksite.

2. The method of claim 1, wherein the first gas contains at least two different gases.

3. The method of claim 2, wherein the first gas contains argon and oxygen.

4. The method of claim 3, wherein the second gas comprises carbon dioxide.

5. The method of claim 4, wherein the carbon dioxide comprises no more than about 5% of the shielding gas mixture.

6. The method of claim 1, wherein the second gas makes up a smaller percentage of the shielding gas mixture relative to the first gas.

7. The method of claim 1, wherein the shielding gas mixture contains at least three different gases.

8. The method of claim 7, wherein the first gas contains at least two different gases.

9. The method of claim 7, wherein the second gas contains at least two different gases.

10. The method of claim 7, wherein one of the at least three different gases in shielding gas mixture is present in less than 2% by volume.

11. The method of claim 1, wherein blending comprises mechanical blending.

12. The method of claim 1, further comprising adjusting a flow rate of the second gas to change a composition of the shielding gas mixture.

13. The method of claim 1, wherein vaporizing the first gas comprises vaporizing the first gas at ambient temperature.

14. The method of claim 1, wherein the first gas is argon and the second gas includes at least two different gases.

15. A method of forming a shielding gas mixture at a worksite at which the shielding gas mixture is used in a welding application, comprising:
providing a first gas in a liquefied state;
vaporizing the first gas to a gaseous state at the worksite;
blending the first gas with a second gas to form the shielding gas mixture suitable for the welding application; and
flowing the shielding gas mixture proximate a weld pool formed on a workpiece located at the worksite.

16. The method of claim 15, wherein the first gas comprises a gas blend wherein a gas of the gas blend comprises a majority of the shielding gas mixture.

17. The method of claim 16, wherein the gas blend comprises argon and oxygen.

18. The method of claim 17, wherein the second gas comprises at least two gases in gaseous state.

19. The method of claim 15, wherein the second gas comprises at least two gases.

20. The method of claim 19, wherein the second gas comprises helium and carbon dioxide.

21. The method of claim 20, wherein the first gas comprises argon.

22. The method of claim 15, further comprising adjusting a flow rate of the second gas to change a composition of the shielding gas mixture.

23. The method of claim 15, wherein vaporizing the first gas comprises vaporizing the first gas at ambient temperature.

24. The method of claim 15, wherein blending comprises mechanical blending.

25. An apparatus for supplying a shield gas mixture at a worksite at which the shielding as mixture is used, comprising:
a liquid gas storage vessel for storing a first gas in liquefied state;
a vaporizer for vaporizering the first gas;
a gas storage vessel for storing a second gas; and
a gas mixer for mixing the first gas and the second gas.

26. The apparatus of claim 25, wherein at least one of the first gas and the second gas contains two gas components.

27. The apparatus of claim 25, wherein the vaporizer is an ambient vaporizer.

28. The apparatus of claim 25, wherein in the gas mixer is a mechanical gas mixer.
